(19) United States
(12) Patent Application Publication
(10) Pub. No.: US 2008/0158532 A1
(43) Pub. Date: Jul. 3, 2008

(54) Image Exposing Apparatus and Microlens Array Unit

(75) Inventor: Hiromi Ishikawa, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/813,814

(22) PCT Filed: Jan. 6, 2006
(86) PCT No.: PCT/JP2006/300319

§ 371 Date: Jul. 12, 2007

(30) Foreign Application Priority Data
Jan. 13, 2005 (JP) 2005-006454

(51) Int. Cl. G03B 27/34; G02B 27/10

(52) U.S. Cl. 355/56; 359/619

(57) ABSTRACT

In an image exposing apparatus that includes: a spatial optical modulation device having multitudes of pixel sections arranged two-dimensionally, each for modulating irradiated light; a light source for irradiating light on the spatial optical modulation device; and an image focusing optical system for focusing an image represented by the light modulated by the spatial optical modulation device on a photosensitive material, which includes image focusing lenses, and a microlens array disposed such that a plurality of microlenses are positioned at the image location of each of the pixel sections focused by the image focusing lenses, degradation in the image quality of an exposed image due to dust adhered to the microlens array is prevented by accommodating the microlens array in a housing having two transparent sections for transmitting the light to be passed through the microlens array and the light passed through the array.

### TECHNICAL FIELD

The present invention relates to an image exposing apparatus. More specifically, the present invention is directed to an image exposing apparatus, in which a photosensitive material is exposed by focusing thereon an optical image represented by light modulated by a spatial optical modulation device.

The present invention also relates to a microlens array unit used for the image exposing apparatus described above.

### BACKGROUND ART

Image exposing systems, in which light modulated by a spatial optical modulation device is passed through an image focusing optical system to focus an image represented by the light on a predetermined photosensitive material in order to expose it with the image are known. Basically, such an image exposing system includes a spatial optical modulation device having multitudes of pixel sections arranged two-dimensionally, each for modulating irradiated light in accordance with a control signal; a light source for irradiating light on the spatial optical modulation device; and an image focusing optical system for focusing an optical image represented by the light modulated by the spatial optical modulation device on a photosensitive material.

In such an image exposing system, a device such as an LCD (liquid crystal display), DMD (digital micromirror device), or the like may preferably be used as the spatial optical modulation device. The DMD described above is a mirror device in which multitudes of rectangular micromirrors that change the angle of the reflecting surface according to a control signal are arranged two-dimensionally on a semiconductor substrate made of, for example, silicon or the like.

In the image exposing system described above, it is often the case that an image needs to be enlarged before being projected on the photosensitive material. If that is the case, an image magnifying and focusing optical system is used as the image focusing optical system. Simple passage of light propagated via the spatial optical modulation device through the image magnifying and focusing optical system may results in a broader light beam from each of the pixel sections of the spatial optical modulation device. Thus, the pixel size in the projected image becomes larger and the sharpness of the image is degraded.

Consequently, a consideration has been given to enlarge and project an image using first and second image focusing optical systems. In this configuration, the first image focusing optical system is disposed in the optical path of the light modulated by the spatial optical modulation device with a microlens array having microlenses arranged in an array, each corresponding to each pixel section of the spatial optical modulation device, being disposed at the image focusing plane of the first image focusing optical system, and the second image focusing optical system for focusing the image represented by the modulated light on a photosensitive material or screen is disposed in the optical path of the light passed through the microlens array. In the configuration described above, the size of the image projected on a photosensitive material or screen may be enlarged, and yet the sharpness of the image may be maintained at high level, since the light from each pixel section of the spatial optical modulation device is focused by each microlens of the microlens array, thereby the pixel size (spot size) in the projected image is narrowed down and maintained at a small size.

One of such image exposing systems that uses a DMD as the spatial optical modulation device in combination with a microlens array is described in Japanese Unexamined patent Publication No. 2001-305663. A similar type of image exposing system is described in Japanese Unexamined patent Publication No. 2004-122470. In the system, an aperture array (aperture plate) having apertures, each corresponding to each microlens of the microlens array, is disposed on the rear side of the microlens array to allow only the light propagated via a corresponding microlens to pass through the aperture. This configuration prevents light from the adjacent microlenses that do not correspond to the aperture of the aperture plate from entering the aperture, so that stray light may be prevented from entering the adjacent pixels. Further, a small amount of light may sometimes be incident on the exposing surface even when the pixels (micromirrors) of the DMD are turned off to shut out the light. In this case also, the configuration described above may reduce the amount of light present on the exposing surface when the pixels of the DMD are turned off.

The conventional image exposing system that combines a spatial optical modulation device with a microlens array has a problem that the amount of light transmitted through each microlens of the microlens array is significantly reduced due to dust adhered to the microlens, thereby image quality of the exposed image is degraded. That is, the amount of light transmitted through the microlens is so reduced by the dust adhered to the microlens that the exposing light intensity on a photosensitive material to be exposed by the light is always kept very weak regardless of the modulation status of the light, causing, for example, a black spot to be recorded on the photosensitive material.

In view of the circumstances described above, it is an object of the present invention to provide an image exposing apparatus that combines a spatial optical modulation device with a microlens array, which is capable of avoiding degradation in the image quality of an exposed image by preventing dust from adhering to the microlens array.

It is a further object of the present invention to provide a microlens array unit capable of avoiding the problem described above.

### DISCLOSURE OF THE INVENTION

The image exposing apparatus according to the present invention is an image exposing apparatus in which a microlens array is accommodated in a housing to prevent dust or the like from directly adhering to the microlenses of the microlens array. More specifically, the image exposing apparatus according to the present invention comprises:

a spatial optical modulation device including multitudes of pixel sections arranged two-dimensionally, each for modulating light irradiated thereon;

a light source for irradiating light on the spatial optical modulation device; and

an image focusing optical system for focusing an image represented by the light modulated by the spatial optical modulation device on a photosensitive material, the image focusing optical system including an image focusing lens for condensing the light reflected from each of the pixel sections of the spatial optical modulation device, and a microlens array having a plurality of microlenses disposed at the image location of each of the pixel sections focused by the image focusing lens,

wherein the microlens array is accommodated in a housing having two transparent sections for transmitting the light to be passed through the microlens array and the light passed therethrough respectively.

Preferably, the housing is an airtight housing and the interior space thereof for accommodating the microlens array is completely isolated from the outside atmosphere. Alternatively, however, the housing may have pores arbitrarily provided therethrough to allow the internal space to communicate with the surrounding atmosphere.

Preferably, at least one of the transparent sections is made of a transparent parallel plate. Alternatively, at least one of the transparent sections may include the lens constituting the image focusing optical system.

Preferably, the air in the interior of the housing is replaced by N₂ gas, O₂ gas, or dried air such that the interior of the housing is filled with the N₂ gas, O₂ gas, or dried air.

Preferably, the present invention is applied to an image exposing apparatus that uses the light with a wavelength within the range from 350 to 450 nm.

Further, in the image exposing apparatus of the present invention, if the aforementioned aperture array having apertures, each corresponding to each of the microlenses of the microlens array, is disposed on the front or rear side of the microlens array, it is preferable that the aperture array is also accommodated in the housing.

The microlens array unit according to the present invention is a microlens array unit, comprising:

a microlens array having microlenses arranged in an array; and

a housing accommodating the microlens array, the housing having two transparent sections for transmitting the light to be passed through the microlens array and the light passed therethrough respectively.

In the image exposing apparatus according to the present invention, the microlens array is accommodated in a housing having two transparent sections for transmitting the light to be passed through the microlens array and the light passed therethrough respectively, so that dust or the like is prevented from directly adhering to the microlens array. Further, even if dust or the like adheres to the transparent sections, the adverse effects on the exposed image is reduced because of the distance between the surface of each of the transparent sections and the microlens array (the reason for this will be detailed later in a preferred embodiment). Thus, degradation in the image quality due to dust or the like may be reduced to a small extent.

Further, in the image exposing apparatus according to the present invention, if the aperture array is also accommodated in the housing, dust or the like is prevented from entering between the aperture array and the microlens array.

In particular, if the wavelength of the light passing through the microlens array is within the short wavelength region from 350 to 450 nm as described above, the light has inherently has high energy. In the image exposing apparatus according to the present invention, the microlens array is disposed such that the microlenses are positioned at image location of the light focused by the image focusing lens. Consequently, the surface of the microlens array located adjacent to the image location having particularly high energy also takes on very high energy so that the surface is likely to collect dust or the like. Thus, degradation in the image quality is more likely to occur. The present invention is particularly preferable to be used in such cases, since degradation in the image quality may be reduced to a small extent.

The microlens array unit according to the present invention comprises a microlens array and a housing accommodating the microlens array, so that the unit may be applied to the image exposing apparatus of the present invention, which is configured in the manner as described above, to provide the advantageous effects for reducing degradation in the image quality of an exposed image caused by dust or the like.

### BRIEF DESCRIPTION OF THE DRAWINGS

FIG. 1 is a perspective view of an image exposing apparatus according to a first embodiment of the present invention, illustrating the overview thereof.

FIG. 2 is a perspective view of a scanner of the image exposing apparatus shown in FIG. 1 illustrating the construction thereof.

FIG. 3A is a plan view of a photosensitive material, illustrating exposed regions thereof.

FIG. 3B is a drawing illustrating the disposition of the exposing area of each exposing head.

FIG. 4 is a perspective view of an exposing head of the image exposing apparatus shown in FIG. 1, illustrating the schematic construction thereof.

FIG. 5 is a schematic cross-section view of the exposing head described above.

FIG. 6 is a partially enlarged view of a digital micromirror device (DMD), illustrating the construction thereof.

FIG. 7A is a drawing for explaining the operation of the DMD.

FIG. 7B is a drawing for explaining the operation of the DMD.

FIG. 8A is a plan view of a DMD, illustrating the arrangement of the exposing beams and scanning lines when the DMD is not inclined relative to the subscanning direction.

FIG. 8B is a plan view of a DMD, illustrating the arrangement of the exposing beams and scanning lines when the DMD is inclined relative to the subscanning direction.

FIG. 9A is a perspective view of a fiber array light source, illustrating the construction thereof.

FIG. 9B is a front elevational view, illustrating the disposition of luminous points at the laser output section of the fiber array light source.

FIG. 10 is a drawing illustrating the construction of a multimode optical fiber.

FIG. 11 is a plan view of a beam-combining laser light source, illustrating the construction thereof.

FIG. 12 is a plan view of a laser module, illustrating the construction thereof.

FIG. 13 is a side view of the laser module shown in FIG. 12, illustrating the construction thereof.

FIG. 14 is a partial front view of the laser module shown in FIG. 12, illustrating the construction thereof.

FIG. 15 is a block diagram illustrating the electrical configuration of the image exposing apparatus described above.

FIG. 16A is a drawing illustrating an example area of use in a DMD.

FIG. 16B is a drawing illustrating an example area of use in a DMD.

FIG. 17 is a perspective view of an airtight housing used in the image exposing apparatus described above, illustrating the overall view thereof.

FIG. 18 is an exploded perspective view of the airtight housing described above, illustrating the airtight housing and components disposed inside thereof.

FIG. 19 is another exploded perspective view of the airtight housing described above, illustrating the airtight housing and components disposed inside thereof viewed from a direction different from that in FIG. 18.

FIG. 20 is an explanatory drawing for explaining advantageous effects of the present invention.

FIG. 21 is a cross-sectional view of an exposing head used in an image exposing apparatus according to a second embodiment of the present invention.

### BEST MODE FOR CARRYING OUT THE INVENTION

Hereinafter, preferred embodiments of the present invention will be described in detail with reference to the accompanying drawings. The image exposing apparatus according to a first embodiment will be described first.

### [Construction of the Image Exposing Apparatus]

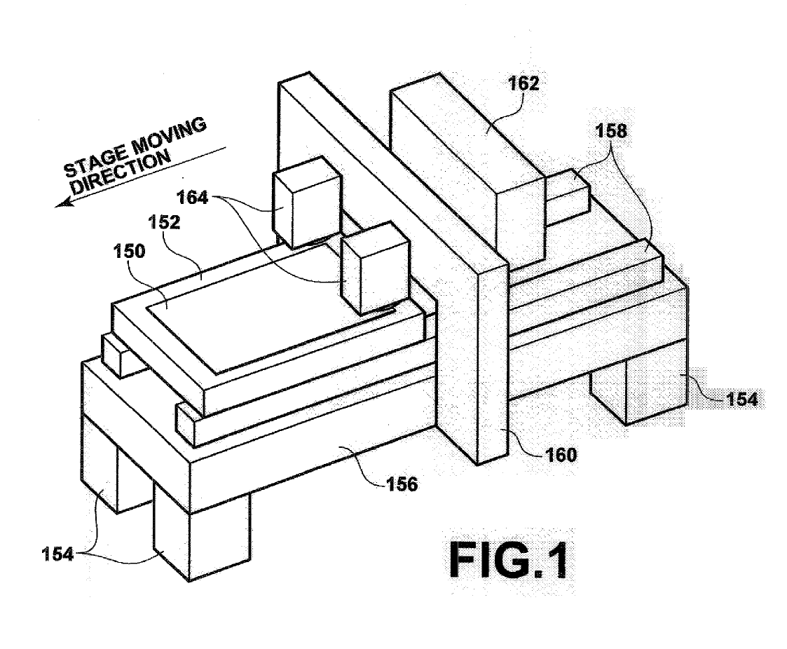

As shown in FIG. 1, the image exposing apparatus of the present embodiment includes a plate-like moving stage 150 for holding a sheet-like photosensitive material 12 thereon by suction. Two guides 158 extending along the moving direction of the stage are provided on the upper surface of a thick plate-like mounting platform 156 which is supported by four legs 154. The stage 152 is arranged such that its longitudinal direction is oriented to the moving direction of the stage, and movably supported by the guides 158 to allow back-and-forth movements. The image exposing apparatus of the present embodiment further includes a stage driving unit 304 (FIG. 15), which will be described later, for driving the stage 152 that serves as a subscanning means along the guides 158.

An inverse U-shaped gate 160 striding over the moving path of the stage 152 is provided at the central part of the mounting platform 156. Each of the ends of the inverse U-shaped gate 160 is fixedly attached to each of the sides of the mounting platform 156. A scanner 162 is provided on one side of the gate 160, and a plurality of sensors 164 (e.g. two) for detecting the front and rear edges of the photosensitive material 150 is provided on the other side. The scanner 162 and sensors 164 are fixedly attached to the gate 160 over the moving path of the stage 152. The scanner 162 and sensors 164 are connected to a controller (not shown) that controls them.

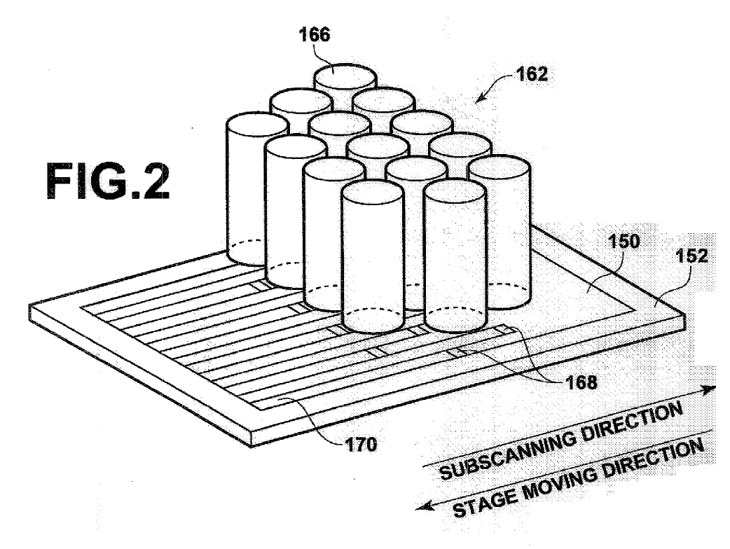

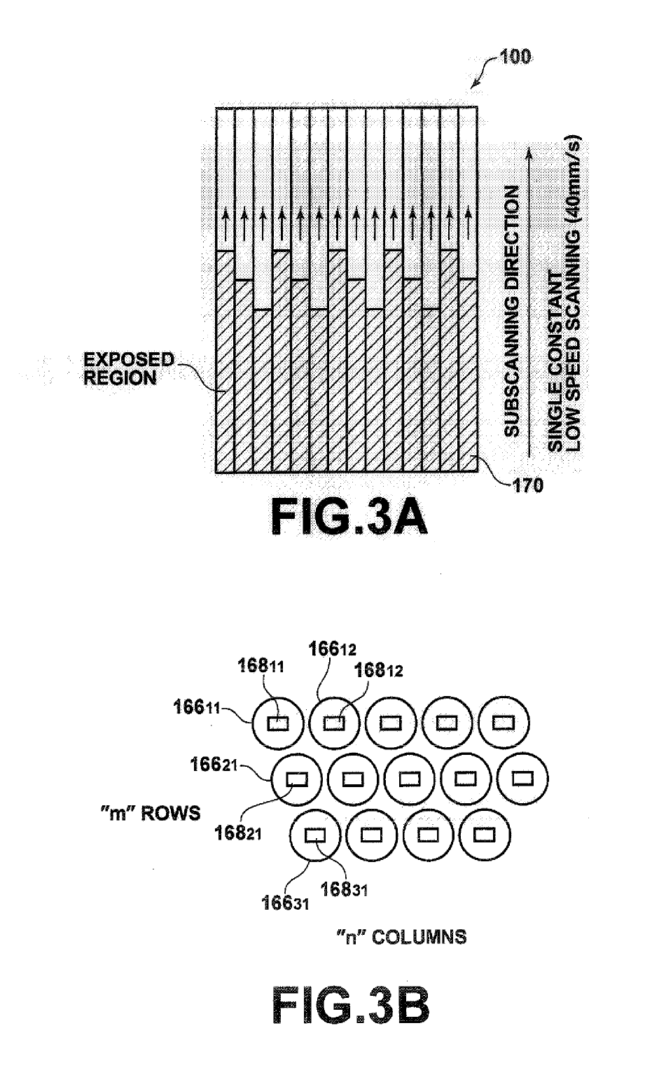

As shown in FIGS. 2 and 3B, the scanner 162 includes a plurality of exposing heads 166 (e.g. fourteen) arranged in matrix form in “m” rows and “n” columns. In this example, four exposing heads 166 are disposed in the third row in relation to the width of the photosensitive material 150. Hereinafter, the exposing head disposed at the n^{th} column of the m^{th} row will be designated as the exposing head 166ₘₙ.

The exposing area 168 of each exposing head 166 has a rectangular form with the short side oriented in the subscanning direction. Accordingly, a stripe-shaped exposed region 170 is formed on the photosensitive material 150 by each of the exposing heads 166 as the stage 152 moves. Hereinafter, the exposing area of the exposing head disposed at the n^{th} column of the m^{th} row will be designated as the exposing area 168ₘₙ.

As shown in FIGS. 3A and 3B, each of the exposing heads 166 arranged linearly in a row is displaced by a predetermined distance (e.g., a natural number multiple of the long side of the exposing area, twice the long side in this case) in the arranging direction such that each of the stripe-shaped exposed regions 170 is disposed without any gap with the adjacent exposed regions 170 in the orthogonal direction to the subscanning direction. Consequently, the unexposed region of the photosensitive material which corresponds to the space between the exposing areas 168₁₁, and 168₁₂ in the first row may be exposed by the exposing area 168₂₁ in the second row and the exposing area 168₃₁ in the third row.

Each of the exposing heads 166₁₁ to 166 mn has a digital micromirror device (DMD) 50, which is available from U.S. Texas Instruments Inc., as the spatial optical modulation device that modulates the incident light beam on a pixel by pixel basis according to image data. The DMD 50 is connected to a controller 302 (FIG. 15) to be described later. The controller 302 includes a data processing section and a mirror drive controlling section. The data processing section of the controller 302 generates a control signal for drive controlling each of the micromirrors within an area of the DMD 50 to be controlled for each of the exposing heads 166 based on inputted image data. The meaning of the “area to be controlled” will be provided later. The mirror drive controlling section controls the angle of the reflecting surface of each of the micromirrors of the DMD 50 for each of the exposing heads 166 based on the control signal generated by the image data processing section. A method for controlling the angle of the reflecting surface of each of the micromirrors will be described later.

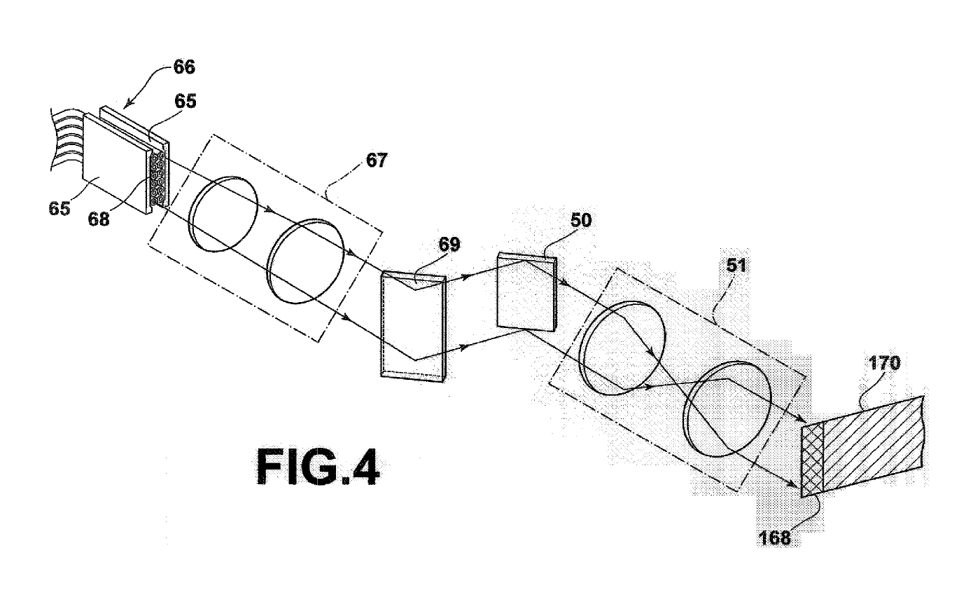

A fiber array light source 66 having a laser output section in which output faces (luminous points) of optical fibers are arranged linearly along the direction corresponding to the direction of the long side of the exposing area 168; a lens system 67 for correcting and focusing the laser beam outputted from the fiber array light source 66 on the DMD; and a mirror 69 for reflecting the laser beam transmitted through the lens system 67 toward the DMD 50 are disposed in this order on the light entry side of the DMD 50. In FIG. 4, the lens system 67 is illustrated schematically.

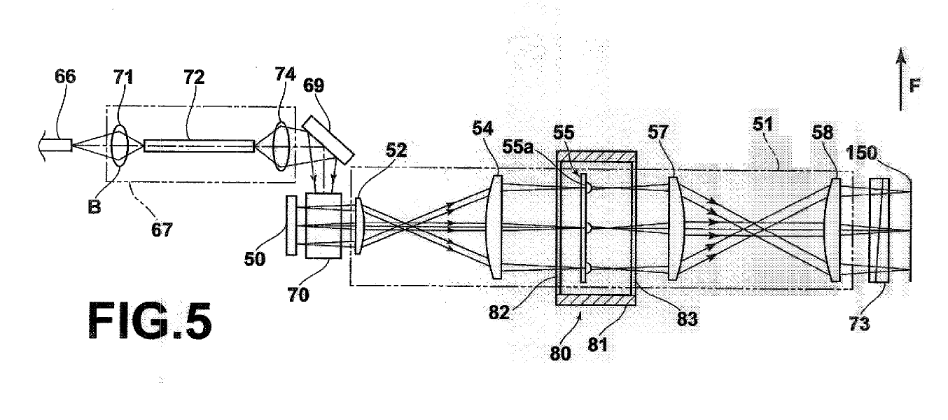

As is illustrated in detail in FIG. 5, the lens system 67 includes a condenser lens 71 for condensing a laser beam B as the illuminating light emitted from the fiber array light source 66, a rod-shaped optical integrator 72 (hereinafter referred to as “rod integrator) placed in the light path of the light transmitted through the condenser lens 71, and an image focusing lens 74 disposed ahead of the rod integrator 72, that is, on the side of the mirror 69. The laser beam emitted from the fiber array light source 66 is irradiated on the DMD 50 through the condenser lens 71, rod integrator 72, and image focusing lens 74 as a substantially collimated light beam having homogeneous luminous intensity in the cross section. The shape and function of the rod integrator 72 will be described in detail later.

The laser beam B outputted from the lens system 67 is reflected by the mirror 69, and irradiated on the DMD 50 through a TIR (total internal reflection) prism 70. In FIG. 4, the TIR prism 70 is omitted.

An image focusing optical system 51 for focusing the laser beam B reflected by the DMD 50 on the photosensitive material 150 is disposed on the light reflecting side of the DMD 50. The image focusing optical system 51 is schematically shown in FIG. 4. As is illustrated in detail in FIG. 5, the image focusing optical system 51 includes a first image focusing optical system constituted by lens systems 52, 54, a second image focusing optical system constituted by lens systems 57, 58, and a microlens array 55 disposed at the image location of the DMD 50 focused by the first image focusing optical system.

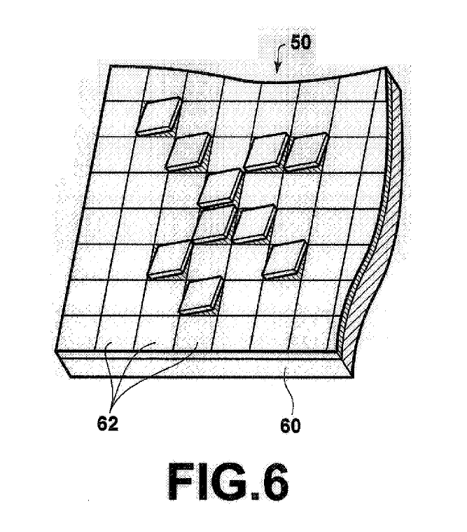

Hereinafter, each of the components will be described in detail. As shown in FIG. 6, the DMD 50 is mirror-device constituted by multitudes of micromirrors 62 (e.g., 1024×768), each forming a pixel, are arranged in a lattice pattern on SRAM cells (memory cells) 60. In each pixel, a rectangular micromirror is provided at the top, which is supported by a support post. A highly reflective material, such as aluminum or the like, is deposited on the surface of the micromirror. The reflectance of the micromirror is not less than 90%, and the arranging pitch of the micromirrors is, for example, 13.7 μm in both vertical and horizontal directions. A silicon-gate CMOS SRAM cell 60, which may be produced on a common manufacturing line for manufacturing semiconductor memories, is provided beneath each of the micromirrors 62 through the support post having a hinge and yoke. The entire DMD is constructed monolithically.

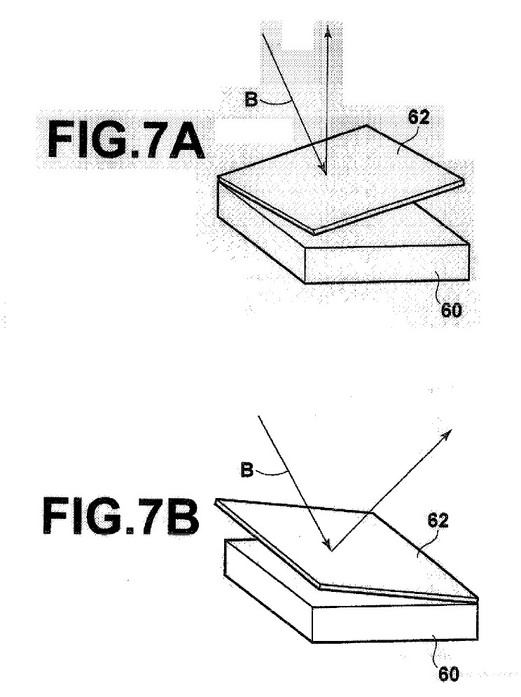

When a digital signal is written into the SRAM cell 60 of the DMD 50, the micromirror supported by the support post is tilted within the range of ±α degrees (e.g., ±12 degrees) centered on the diagonal line relative to the substrate on which the DMD 50 is mounted. FIG. 7A shows the micromirror 62 tilted by +α degrees, which means that it is in on-state, and FIG. 7B shows the micromirror 62 tilted by −α degrees, which means that it is in off-state. Accordingly, by controlling the tilt of the micromirror 62 in each pixel of the DMD 50 according to image signals as shown in FIG. 6, the laser beam B incident on the DMD 50 is reflected to the tilt direction of each of the micromirrors 62.

FIG. 6 is a partially enlarged view of the DMD 50, illustrating an example state in which some of the micromirrors in a portion of the DMD 50 are controlled to tilt by + or −α degrees. The on-off control of each of the Mir mirrors 62 is implemented by the controller 302 connected to the DMD 50. A light absorption material (not shown) is disposed in the propagating direction of the laser beam B reflected by the micromirrors which are in off-state.

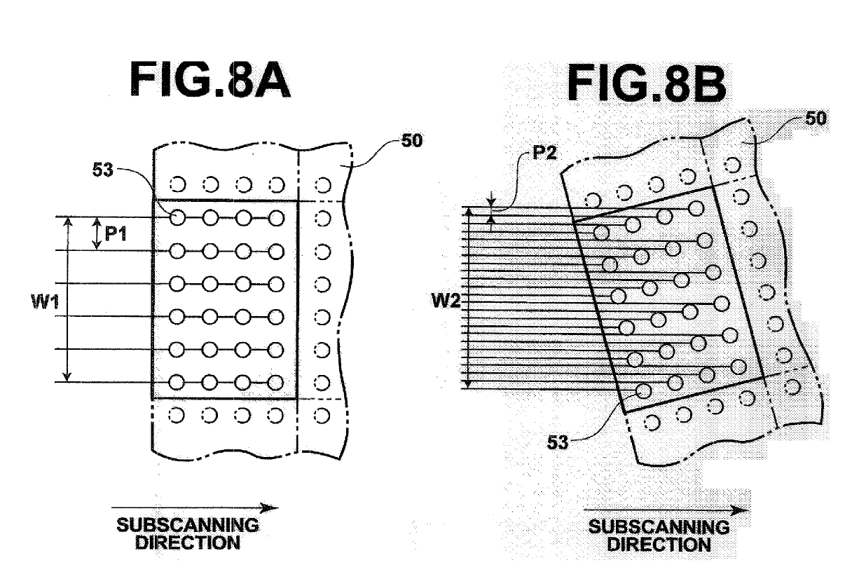

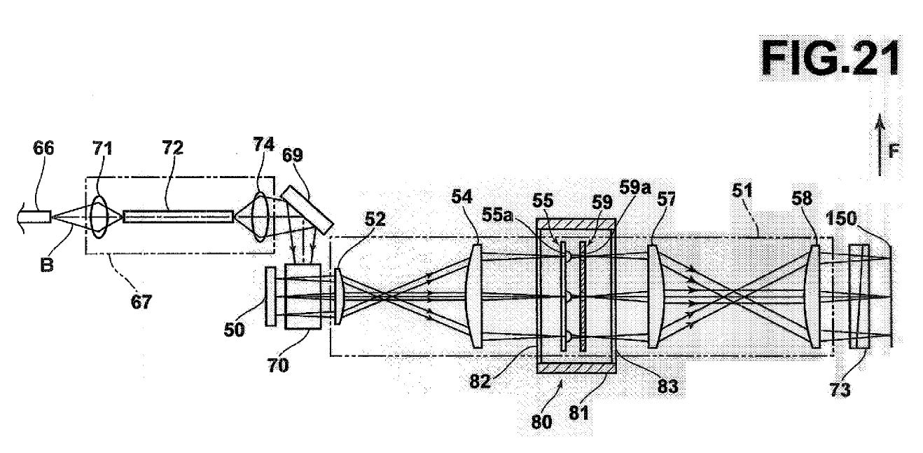

Preferably, the DMD 50 is disposed in slightly inclined manner so that the short side thereof forms a predetermined angle θ (e.g., 0.1 to 5 degrees) with the subscanning direction. FIG. 8A illustrates the scan trace of the reflected light image 53 (exposing beam) produced by each of the micromirrors when the DMD 50 is not inclined, and FIG. 8B illustrates the scan trace of the exposing beam 53 from each of the micromirrors when the DMD 50 is inclined.

The DMD 50 includes multitudes of micromirror columns (e.g., 756) disposed in the transverse direction, each having a multitude of micromirrors (e.g., 1024) disposed in the longitudinal direction. As shown in FIG. 8B, the pitch P₂ between the scan traces (scanning lines) of the exposing beams 53 produced by the micromirrors is narrower when DMD 50 is inclined than the pitch P₁ when it is not inclined, and image resolution is improved significantly. In the mean time, the inclination angle of the DMD 50 relative to the subscanning direction is very small so that a scanning width W₂ when the DMD is inclined is approximately the same as a scanning width W₁ when it is not inclined.

Further, the same scanning line is exposed a plurality of times by the different micromirror columns (multiple exposures). The multiple exposures allow fine control of exposing position and a high resolution exposure maybe realized. Further, the seam between a plurality of exposing heads disposed in the main scanning direction may be smoothed out by the fine exposing position control.

The similar effect may be obtained by arranging the micromirror columns in a zigzag pattern by displacing each of the micromirror columns by a predetermined distance in the direction which is orthogonal to the subscanning direction, instead of inclining the DMD 50.

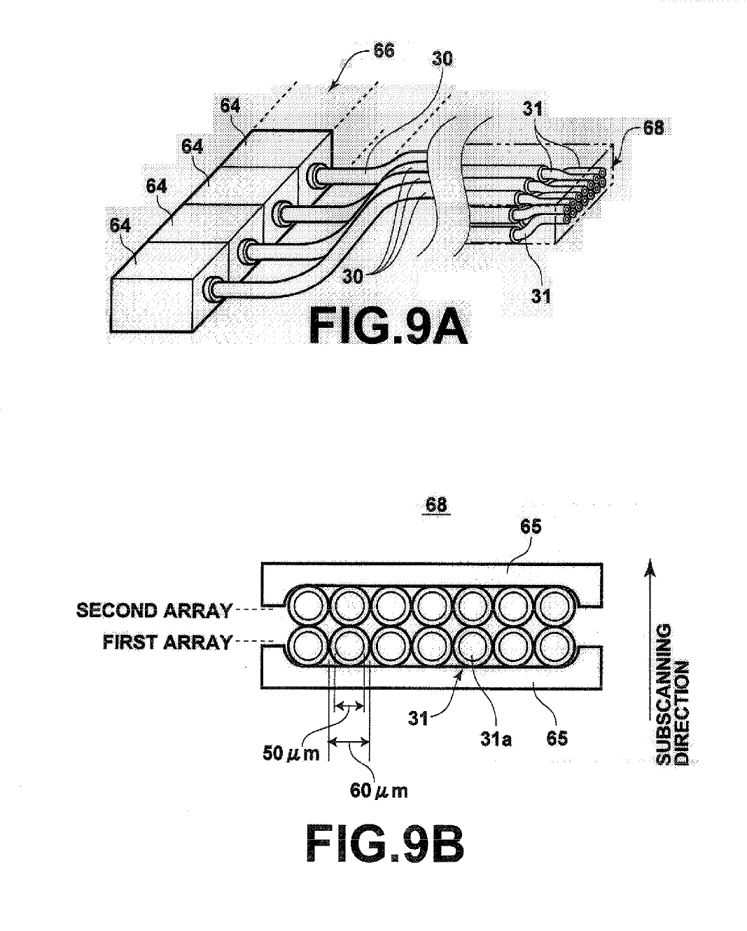

As shown in FIG. 9A, the fiber array light source 66 includes a plurality of laser modules 64 (e.g., 14), and one end of a length of multi-mode optical fiber 30 is connected to each of the laser modules 64. A length of optical fiber 31 having the same core diameter and smaller clad diameter than the multi-mode optical fiber 30 is spliced to the other end of each of the multi-mode optical fibers 30. As is illustrated in detail in FIG. 9B, each end face of seven optical fibers 31 on the side opposite to the multimode fiber 30 is aligned along the main scanning direction which is orthogonal to the subscanning direction, and two arrays of the end faces are disposed to form a laser output section 68.

The laser output section 68 constituted by the end faces of the optical fibers 31 is fixedly sandwiched by two support plates 65 having a flat surface. Preferably, a transparent protection plate made of glass or the like is provided on each of the light output faces of the optical fibers 31 for protection. The light output face of each of the optical fibers 31 is likely to collect dust and prone to deterioration since it has a high optical density. Provision of the protection plate described above may prevent adhesion of dust and delay the deterioration.

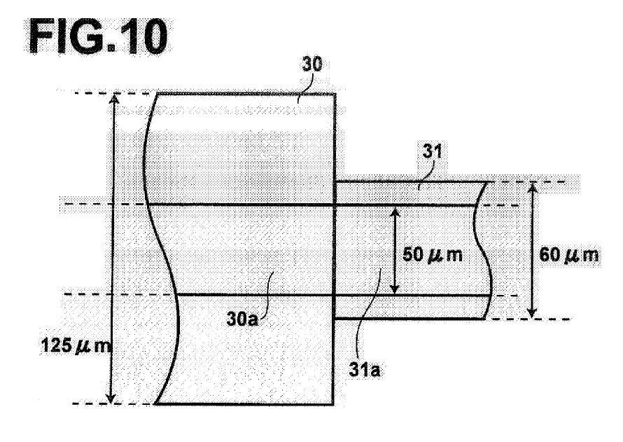

In the present embodiment, the optical fiber 31 having a smaller clad diameter with the length of around 1 to 30 cm is spliced coaxially to the tip of the laser beam output side of the multimode fiber 30 having a greater clad diameter as shown in FIG. 10. The optical fibers 30, 31 are spliced together by fusion splicing the input face of the optical fiber 31 to the output face of the optical fiber 30 with the core axes being aligned. As described earlier, the optical fiber 31 has the same core diameter as the multimode optical fiber 30.

As for the multimode optical fiber 30 and optical fiber 31, a step index type optical fiber, graded index type optical fiber, or hybrid type optical fiber may be used. For example, a step index type optical fiber available from Mitsubishi Cable Industries, Ltd. may be used. In the present embodiment, the multimode optical fiber 30 and optical fiber 31 are step index type. The Multimode optical fiber 30 has a clad diameter of 125 μm, a core diameter of 50 μm, a NA of 0.2, and a transmittance for the coating of input face of 99.5%. The optical fiber 31 has a clad diameter of 60 μm, a core diameter of 50 μm, and a NA of 0.2.

However, the clad diameter of the optical fiber 31 is not limited to 60 μm. The clad diameter of many optical fibers used for a conventional optical fiber light source is 125 μm. Preferably, the clad diameter of the multimode optical fiber is not greater than 80 μm, and more preferably, not greater than 60 μm, since a smaller clad diameter results in a deeper focal depth. Preferably, the clad diameter of the optical fiber 31 is not less than 10 μm, since a single mode optical fiber requires a core diameter of at least 3 to 4 μm. Preferably, the optical fibers 30, 31 have the same core diameter from the stand point of coupling efficiency.

It is not necessarily required to use two different types of optical fibers 30, 31 having different clad diameters with each other by fusion splicing them together (so-called taper splicing). The fiber array light source may be formed by bundling a plurality of optical fibers having the same clad diameter (e.g., optical fibers 30 in FIG. 9A), each without a different type of optical fiber being spliced thereto.

The laser module 64 is constituted by a beam combining laser light source (fiber light source). The beam combining laser light source includes a plurality of transverse multimode or single mode GaN system semiconductor laser chips LD1, LD2, LD3, LD4, LD5, LD6 and LD7 fixedly mounted on a heat block 10; collimator lenses 11, 12, 13, 14, 15, 16, and 17, each provided for each of the GaN system semiconductor lasers LD1 to LD7; a condenser lens 20; and a multimode optical fiber 30. The number of the semiconductor lasers is not limited to seven, and different number of the semiconductor lasers may be employed. Further, instead of the seven separate collimator lenses 11 to 17, a collimator lens array in which these collimator lenses are integrated may be used.

Each of the GaN system semiconductor lasers LD1 to LD7 has substantially the same oscillation wavelength (e.g., 405 nm) and maximum output (e.g., around 100 mW for multimode laser, and 50 mW for single mode laser). The output of each of the GaN system semiconductor lasers LD1 to LD7 may differ with each other below the maximum output power. As for the GaN system semiconductor lasers LD1 to LD7, a laser that oscillates at a wavelength in the wavelength range from 350 to 450 nm other than at 405 nm may also be used.

The beam combining laser light source is installed in a box type package 40 having a top opening together with other optical elements. The package 40 includes a package lid formed to seal the opening of the package 40. A sealing gas is introduced into the package 40 after being deaerated, and the opening of the package 40 is sealed with the package lid 41 to air-tightly seal the beam combining laser light source within the closed space (sealing space) created thereby.

A base plate 42 is fixedly attached on the bottom surface of the package 40, and the heat block 10, a collimator lens holder 45 for holding the collimator lens 20, and a fiber holder 46 for holding the input end of the multimode fiber 30 are attached on the upper surface of the base plate 42. The output end of the multimode fiber 30 is drawn outside through an aperture provided on the wall of the package 40.

A collimator lens holder 44 is attached to a lateral surface of the heat block 10, and the collimator lenses 11 to 17 are held thereat. An aperture is provided on a lateral side wall through which wiring for supplying a drive current to the GaN system semiconductor lasers LD1 to LD7 is drawn outside.

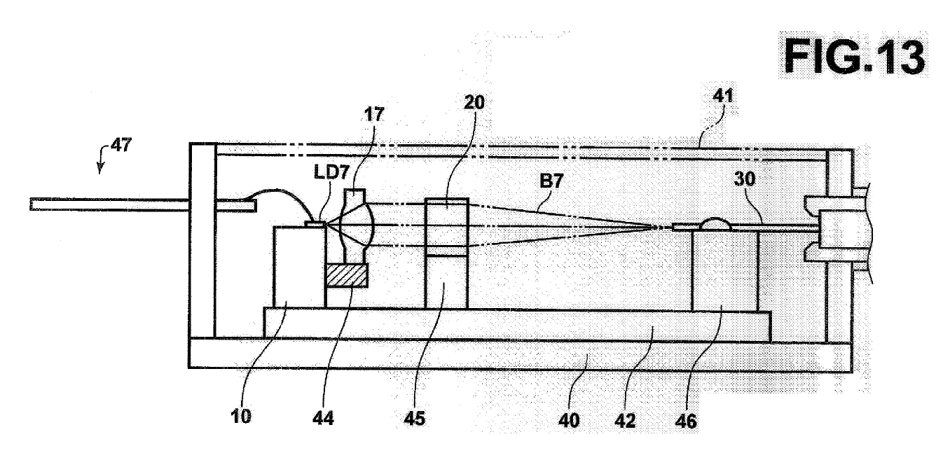

In FIG. 13, only the GaN system semiconductor laser LD1 out of the seven semiconductor lasers LD1 to LD7, and the collimator lens 17 out of the seven collimator lenses 11 to 17 are shown for clarity.

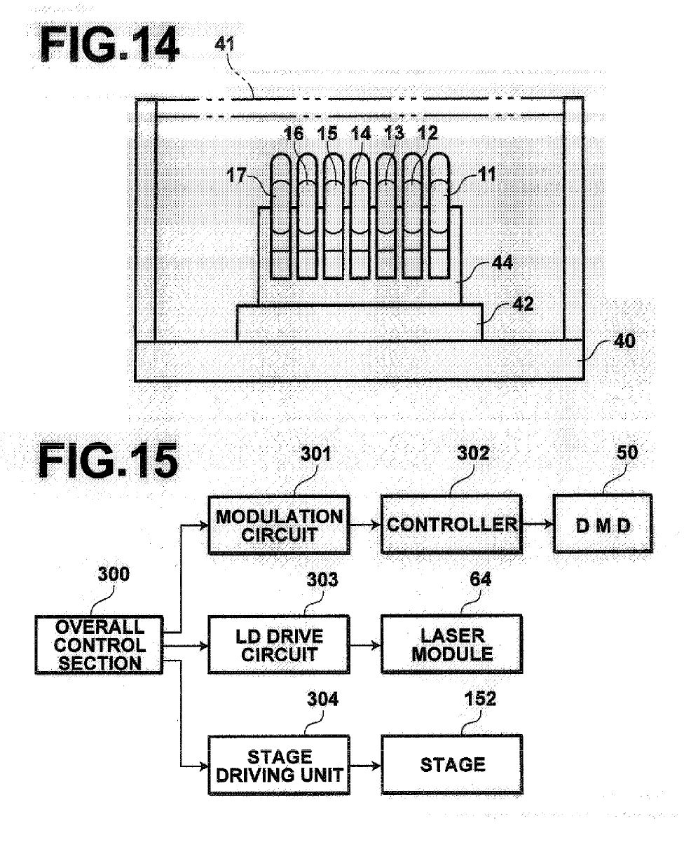

FIG. 14 is a front view of the mounting section of the collimator lenses 11 to 17, illustrating the front geometry thereof. Each of the collimator lenses 11 to 17 is formed such that a region including the optical axis of a circular lens having an aspheric surface is sliced out by parallel planes in an elongated form. The elongated collimator lens may be formed, for example, by molding resin or optical glass. The collimator lenses 11 to 17 are disposed closely with each other in the arranging direction of the luminous points of the GaN system semiconductor lasers LD1 to LD7 (left-to-right direction in FIG. 14) such that the length direction of the collimator lenses 11 to 17 is oriented in the direction which is orthogonal to the arranging direction of the luminous points of the GaN system semiconductor lasers LD1 to LD7.

In the mean time, as for the GaN system semiconductor lasers LD1 to LD7, lasers that include an active layer with a luminous width of 2 μm and emit respective laser beams B1 to B7 with the beam divergence angles of, for example, 10 degrees and 30 degrees respectively in the parallel and orthogonal directions to the active layer is used. The GaN system semiconductor lasers LD1 to LD7 are disposed such that the luminous points thereof are aligned linearly in the direction parallel to the active layer.

Accordingly, the laser beams B1 to B7 emitted from the respective luminous points enter the respective elongated collimator lenses 11 to 17 with the direction having a larger beam divergence angle corresponds to the length direction and the direction having a smaller beam divergence angle corresponds to the width direction (direction orthogonal to the length direction) of the collimator lenses. That is, the width of each of the collimator lenses 11 to 17 is 1.1 mm, the length thereof is 4.6 mm, and the beam diameters of the laser beams B1 to B7 entering the collimator lenses 11 to 17 in the horizontal and vertical directions are 0.9 mm and 2.6 mm respectively. Each of the collimator lenses 11 to 17 has a focal length f₁ of 3 mm and a NA of 0.6, which is arranged with a pitch of 1.25 mm.

The condenser lens 20 is formed such that a region including the optical axis of a circular lens having an aspheric surface is sliced out by parallel planes in an elongated form. It is disposed such that the long side thereof corresponds to the arranging direction of the collimator lenses 11 to 17, i.e., horizontal direction, and short side thereof corresponds to the direction orthogonal to the horizontal direction. The condenser lens 20 has a focal length f₂ of 23 mm and a NA of 0.2. The condenser lens 20 is also formed by molding resin or optical glass.

The microlens array 55 shown in FIG. 5 includes multitudes of microlenses 55a arranged two-dimensionally, each corresponding to each pixel or micromirror 62 of the DMD 50. Although the DMD 50 has 1024 pieces×768 columns of micromirrors in total, only 1024 pieces×256 columns are driven in the present embodiment as will be described later. Thus, corresponding number of 1024 pieces×256 columns of the microlenses 55a are disposed. The size of the microlens 55a is 40 μm in both vertical and horizontal directions. As an example, the microlens 55a is made of optical glass BK7, and has a focal length of 0.19 mm and a NA (numerical aperture) of 0.11.

The microlens array 55 is accommodated in an airtight housing 80. Basically, the airtight housing 80 includes a lens mirror cylinder 81, and parallel plate type cover glasses 82, 83 for transmitting the laser beam B to be inputted to the microlens array 55 and the laser beam B passed therethrough respectively, and includes the microlens array 55 in the enclosed space which is isolated from the outside atmosphere.

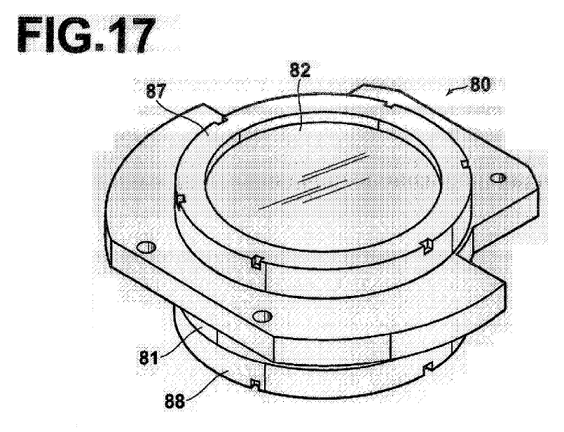

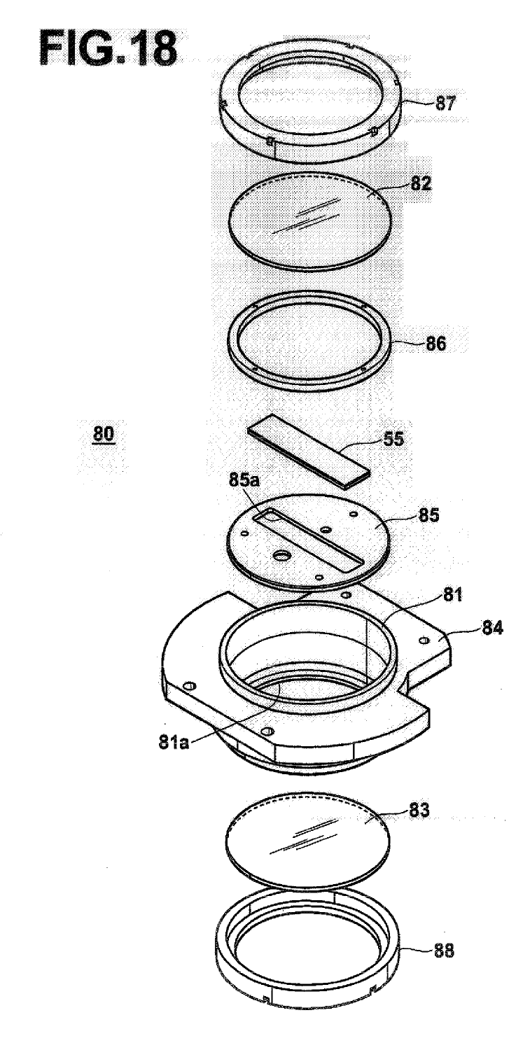

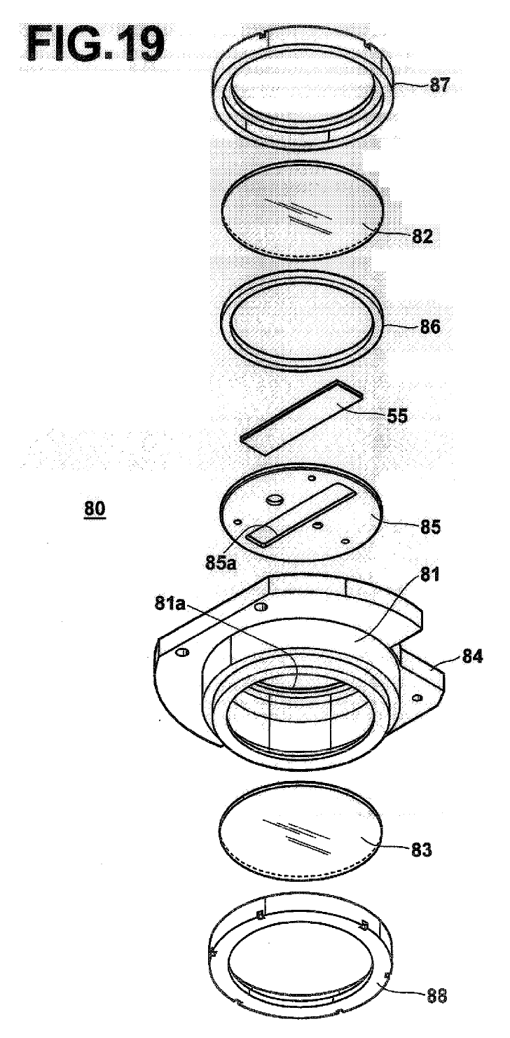

FIG. 17 is a detailed perspective view of the airtight housing 80. FIGS. 18 and 19 are exploded perspective views of the airtight housing 80 viewed from the cover glass 82 and cover glass 83 respectively. Hereinafter, the mounting structure for the microlens array 55 within the airtight housing will be described with reference to these drawings.

A mounting member 84 is fixedly attached to the lens mirror cylinder 81 made of, for example, aluminum, and the lens mirror cylinder 81 is fixedly attached to the body of the image exposing apparatus through the mounting member 84. The microlens array 55 is fixedly attached to a plate-like microlens holder 85 with an adhesive or the like. The microlens holder 85 has a light transmitting aperture 85a for transmitting the leaser beam B condensed by the microlens array 55.

The microlens holder 85 is placed on a flared portion 81a formed on the inner circumference of the lens mirror cylinder 81, and a holding ring 86 made of, for example, aluminum is threadably mounted on the inner circumference of the lens mirror cylinder 81 from above to press fixing the microlens holder 85 to the flared portion 81a. The cover glass 82 made of, for example, BK7 glass or the like is placed at the top end of the lens mirror cylinder 81, and a holding ring 87 made of, for example, aluminum is threadably fixed to the outer circumference of the lens mirror cylinder on top of the cover glass 82 to attach the cover glass 82 to the lens mirror cylinder 81. The cover glass 83 is placed at the bottom end of the lens mirror cylinder 81, and a holding ring 88 made of, for example, aluminum for pressing the cover glass 83 onto the bottom end of the lens mirror cylinder 81 is threadably fixed to the outer circumference of the lens mirror cylinder 81. This causes the cover glass 83 made of, for example, BK7 glass or the like to be attached to the lens mirror cylinder 81.

In this way, the microlens array 55 is installed in the enclosed space defined by the lens mirror cylinder 81, cover glass 82, and cover glass 83.

The image of the DMD 50 is focused on the microlens array by the first image focusing optical system constituted by the lens systems 52, 54 shown in FIG. 5 by magnifying it three times, and the image formed after the microlens array is focused and projected on the photosensitive material 150 by the second image focusing optical system constituted by the lens systems 57, 58 by magnifying it 1.6 times. Accordingly, the image of the DMD 50 is focused and projected on the photosensitive material 150 in magnified form with an overall magnification ratio of 4.8 times.

In the present embodiment, a prism pair 73 is disposed between the second image focusing optical system and photosensitive material 150, and the focus of the image on the photosensitive material 150 may be adjusted by moving the prism pair 73 in up and down directions in FIG. 5. In FIG. 5, the photosensitive material 150 is fed in the subscanning direction indicated by the arrow F.

The electrical configuration of the image exposing apparatus according to the present invention will be described with reference to FIG. 15. As shown in FIG. 15, an overall control section 300 connects to a modulation circuit 301, which in turn connects to a controller 302 for controlling the DMD 50. The overall control section 300 also connects to an LD drive circuit 303 for driving laser modules 64. Further, it connects to a stage driving unit 304 for driving the stage 152.

### [Operation of the Image Exposing Apparatus]

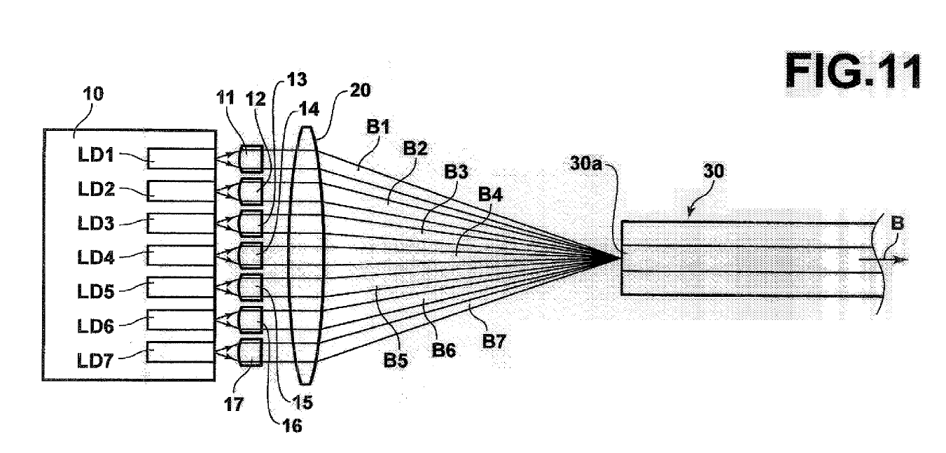

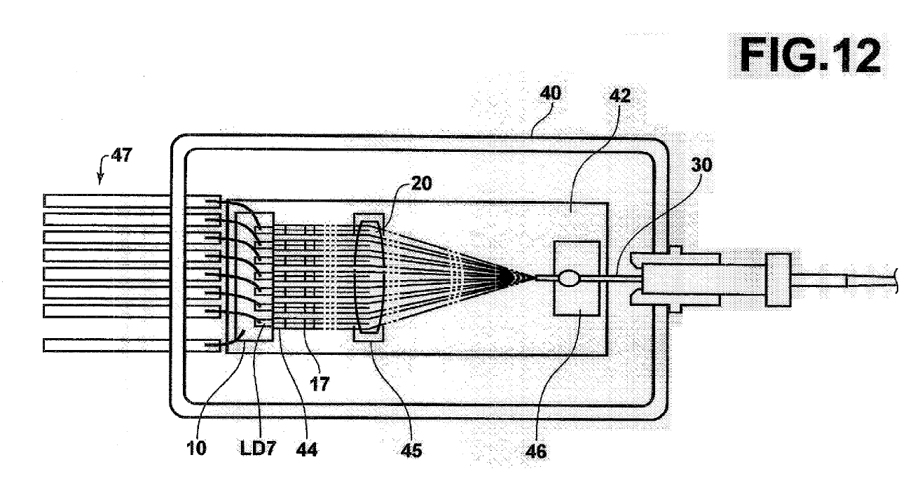

The operation of the aforementioned image exposing apparatus will be described hereinafter. In each of the exposing heads of the scanner 162, each of the laser beams B1, B2, B3, B4, B5, B6, and B7 emitted in diverging manner from each of the GaN system semiconductor lasers LD1 to LD7 (FIG. 11), which constitute a beam combining light source of the fiber array light source 66, is collimated by each of the corresponding collimator lenses 11 to 17. The collimated laser beams B1 to B7 are condensed by the condenser lens 20 and focused on the input end face of a core 30a of the multimode optical fiber 30.

In the present embodiment, the collimator lenses 11 to 17 and condenser lens 20 constitute a condensing optical system, and the condensing optical system and multimode optical fiber 30 constitute a beam combining optical system. That is, laser beams B1 to B7 condensed by the condenser lens 20 in the manner as described above enter the core 30a of the multimode optical fiber 30 to propagate therethrough, and exit from the optical fiber 31, which is spliced to the output end face of the multimode optical fiber 30, as a single combined laser beam B.

In each of the laser modules 64, when the coupling efficiency of the laser beams B1 to B7 to the multimode optical fiber 30 is 0.9, and output power of each of the GaN system semiconductor lasers LD1 to LD7 is 50 mW, a combined laser beam B having an output power of 315 mW (50 mW×0.9×7) from each of the optical fibers 31 arranged in arrays. Accordingly, from the total number of 14 optical fibers, a laser beam B having an output power of 4.4W (0.315×14) may be obtained.

When performing an image exposure, image data according to the image to be exposed are inputted from the modulation circuit 301 shown in FIG. 15 to the controller 302 of the DMD 50 and temporarily stored in the frame memory thereof. The image data are data in which the gray level of each of the pixels forming the image is represented by a binary value (presence/absence of a dot).

The stage 152 with a photosensitive material 150 suctioned thereon is moved along the guides 158 at a constant speed from the upper stream to the down stream of the gate 160. When the stage 152 passes under the gate 160, and the front edge of the photosensitive material 150 is detected by the sensors 164 attached to the gate 160, the image data stored in the frame memory are sequentially read out for a plurality of lines at a time. Then, a control signal for each of the exposing heads 166 is generated on a head-by-head basis by the data processing section based on the readout image data, and each of the micromirrors of the DMD 50 in each of the exposing heads 166 is on-off controlled on a head-by-head basis by the mirror drive controlling section based on the generated control signal. In the present embodiment, the size of the micromirror serving as a single pixel section is 13.7 μm×13.7 μm.

While the laser beam B is irradiated on the DMD 50 from the fiber array light source 66, a laser beam reflected by a micromirror of the DMD 50 driven to on-state is focused on the photosensitive material 150 through the lens system 51. In this way, the laser beam emitted from the fiber array light source 66 is on-off controlled on a pixel-by-pixel basis, and the photosensitive material 150 is exposed with the number of pixels (exposing areas 168)which is substantially equal to that of the pixels of the DMD used. The photosensitive material 150 is moved with the stage 152 at a constant speed so that the photosensitive material 150 is subscanned by the scanner 162 in the direction opposite to the stage moving direction, and a stripe-shaped exposed region 170 is formed by each of the exposing heads 166.

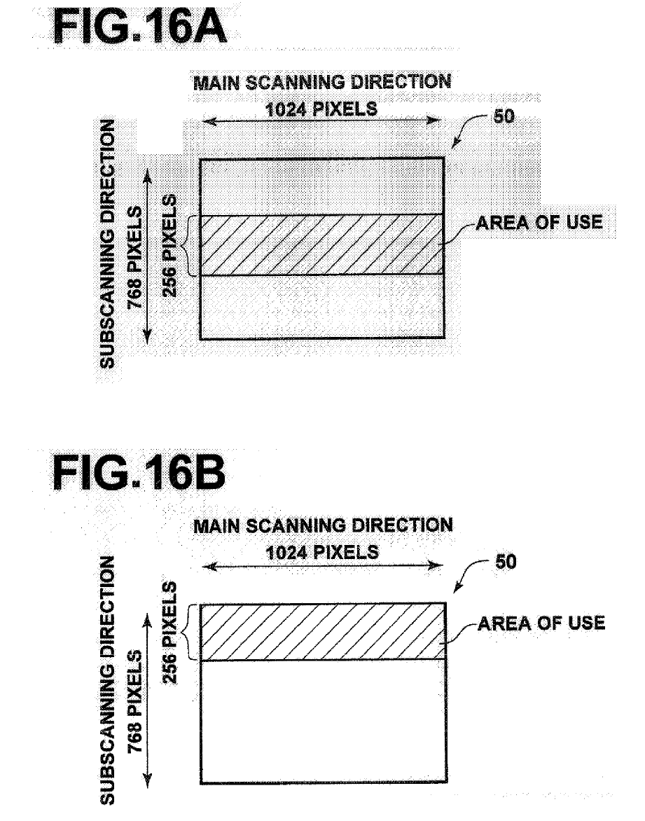

Although DMD 50 includes 768 arrays of micromirrors disposed in the subscanning direction, each having 1024 pieces of micromirrors disposed in the main scanning direction, only a part of the micromirror arrays (e.g., 1024 pieces×256 arrays) is drive controlled by the controller 302 in the present embodiment as shown in FIGS. 16A and 16B.

In this case, micromirror arrays disposed either in the central area (FIG. 16A), or top (or bottom) end area (FIG. 16B) of the DMD 50 may be used. In addition, if some of the micromirrors become defective, a micromirror array or arrays having no defective micromirror may be used instead of the micromirror array or arrays having the defective micromirrors. In this way, the micromirror arrays may be changed accordingly depending on the situation.

The DMD 50 has a certain limited data processing speed. The modulation speed per line is inversely proportional to the number of pixels used. Therefore, the modulation speed per line may be increased by using only a part of the entire micromirror arrays. In the mean time, for the exposing method in which the exposing heads are moved continuously relative to the exposing surface, not all of the pixels located in the subscanning direction need to be used.

When the subscanning of the photosensitive material 150 by the scanner 162 is completed, and the rear edge of the photosensitive material 150 is detected by the sensors 164, the stage 152 is returned to the original position on the uppermost stream of the gate 160 along the guides 158 by the stage driving unit 304. Thereafter, it is moved again along the guides 158 from the upper stream to down stream of the gate 160 at a constant speed.

Illumination optics, which are constituted by the fiber array light source 66, condenser lens 71, rod integrator 72, image forming lens 74, mirror 69, and TIRprism 70 shown in FIG. 5, for irradiating the laser beam B as illumination light on the DMD 50 will be described herein below. The rod integrator 72 is, for example, a transparent rod formed in a square pole. While the laser beam B propagates in the rod integrator 72 by total reflection, the intensity distribution within the cross-section of the laser beam B is homogenized. The input and output faces of the rod integrator 72 is provided with an antireflection coating to improve the transmittance. Provision of the laser beam B, which serves as the illumination light, having a highly homogenized intensity distribution within the cross-section in the manner as described above may result in the illumination light having a homogeneous light intensity, allowing a high resolution image to be exposed on the photosensitive material 150.

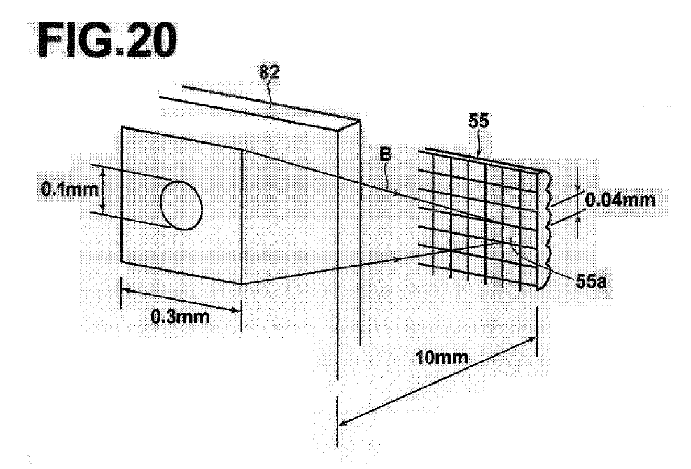

In the apparatus according to the present embodiment, the microlens array 55 is accommodated in the airtight housing 80, so that dust or the like is prevented from directly adhering to the microlens array 55. Further, dust or the like may adhere to the surface of each of the cover glasses 82, 83 that constitute the airtight housing, the adverse effects on the exposed image due to the acquired dust or the like may be reduced because of the distance between the surface of each of the cover glasses 82, 83 and the microlens array 55. Hereinafter, the reason for this will be described by taking the situation on the part of the cover glass 82 as an example with reference to FIG. 20.

The microlens array 55 is disposed such that each of the microlenses 55a is positioned at the image location of each of the corresponding micromirrors 62 of the DMD 50 focused by the first image focusing system constituted by the lens systems 52, 54. Accordingly, the laser beam B transmits through the cover glass 82 in gradually converging manner. In the present embodiment, the beam divergence angle of the laser beam B is 0.006 radians for diffraction and 0.008 radians for NA, totaling in 0.014 radians. In the present embodiment, the size of the microlens 55a is 40 μm (0.04 mm) in both vertical and horizontal directions as described earlier. The distance between the image location focused by the first image focusing optical system and the surface of the cover glass 82 is 10 mm. Thus, the size of the laser beam B on the surface of the cover glass 82 is 0.3 mm×0.3 mm.

Under these conditions, for example, if an entirely light blocking particle of dust with a diameter of 0.1 mm adheres to the surface of the microlens array 55, the exposure value of approximately four pixels (approximately four microlenses) are reduced to zero on the exposed image. In contrast, in the present embodiment, if a particle of dust having the same size as that described above adheres to the surface of the cover glass 82, the adverse effects extend to approximately nine pixels, but the exposure value of each of the affected pixels is reduced only by 1/9. Thus, the present embodiment may significantly reduce the adverse effects of dust compared with the case where dust is allowed to directly adhere to the microlens array 55.

So far the situation on the part of the cover glass 82 has been described. Degradation in the image quality of an exposed image which may be caused by dust or the like acquired on the surface of the cover glass 83 may also be prevented, since the laser beam B exits from the cover glass 83 in gradually diverging manner.

In the present embodiment, the wavelength of the laser beam B is 405 nm, which is within the range from 350 to 450 nm described earlier. Thus, the laser beam B has high energy and the surface of the microlens array is more likely to collect dust or the like, which in turn is more likely to cause degradation in the image quality of an exposed image. But by virtue of the present invention, the image quality degradation is reduced to a small extent.

Hereinafter, a second embodiment of the present invention will be described. FIG. 21 is a cross-sectional view of an exposing head of the image exposing apparatus according to the second embodiment. The exposing head of the second embodiment basically differs from the exposing head shown in FIG. 5 in that it further includes an aperture array 59. The aperture array 59 is made of an opaque member with multitudes of apertures (openings) 59a formed therethrough, each corresponding to each of the microlenses of the microlens array 55.

This configuration allows the light reflected from each of the micromirrors 55a of the DMD 50 to enter a corresponding aperture 59a of the aperture array 59 only, and does not allow the light reflected from the adjacent micromirrors to enter the aperture 59a not corresponding to these microlens, so that the extinction ratio may be improved. Further, in the present embodiment, the aperture array 59 is also accommodated in the airtight housing 80, so that dust or the like is prevented from entering between the aperture array 59 and the microlens array 55.

In the first and second embodiments described above, the cover glasses 82, 83 are used as transparent sections for transmitting the laser beam B to be passed through the microlens array 55 and the laser beam B passed therethrough respectively. Alternatively, the transparent section may be formed using a lens constituting an image focusing optical system, such as the lens system 54 or 57 in the configuration shown in FIG. 5 or 21. That is, in this case, the lens system 54 or 57 may be incorporated into the lens mirror cylinder 81.

Preferably, the air in the interior of the airtight housing 80 is purged and replaced by clean N₂ gas, O₂ gas, or dried air, after the microlens array 55 and aperture array 59 are installed therein. This may prevent the microlens array 55 and aperture array 59 from acquiring the dust or the like contained in the air within the airtight housing 80. Further, it is known that O₂ gas has advantageous effects to prevent dust or the like from adhering to a plane through which light with a short wavelength is transmitted.

1.-7. (canceled)

8. An image exposing apparatus, comprising:
a spatial optical modulation device including multitudes of pixel sections arranged two-dimensionally, each for modulating light irradiated thereon;
a light source for irradiating light on the spatial optical modulation device; and
an image focusing optical system for focusing an image represented by the light modulated by the spatial optical modulation device on a photosensitive material, the image focusing optical system including an image focusing lens for condensing the light reflected from each of the pixel sections of the spatial optical modulation device, and a microlens array having a plurality of microlenses disposed at the image location of each of the pixel sections focused by the image focusing lens,
wherein the microlens array is accommodated in a housing having two transparent sections for transmitting the light to be passed through the microlens array and the light passed therethrough respectively.

9. The image exposing apparatus according to claim 8, wherein at least one of the transparent sections is made of a parallel plate.

10. The image exposing apparatus according to claim 8, wherein at least one of the transparent sections comprises the lens constituting the image focusing optical system.

11. The image exposing apparatus according to claim 8, wherein the air in the interior of the housing is replaced by N₂ gas, O₂ gas, or dried air such that the interior of the housing is filled with the N₂ gas, O₂ gas, or dried air.

12. The image exposing apparatus according to claim 9, wherein the air in the interior of the housing is replaced by N₂ gas, O₂ gas, or dried air such that the interior of the housing is filled with the N₂ gas, O₂ gas, or dried air.

13. The image exposing apparatus according to claim 10, wherein the air in the interior of the housing is replaced by N₂ gas, O₂ gas, or dried air such that the interior of the housing is filled with the N₂ gas, O₂ gas, or dried air.

14. The image exposing apparatus according to claim 8, wherein the wavelength of the light is within the range from 350 to 450 mn.

15. The image exposing apparatus according to claim 9, wherein the wavelength of the light is within the range from 350 to 450 nm.

16. The image exposing apparatus according to claim 10, wherein the wavelength of the light is within the range from 350 to 450 mn.

17. The image exposing apparatus according to claim 8, wherein an aperture array is disposed on the front or rear side of the microlens array, the aperture array having apertures, each corresponding to each of the microlenses of the microlens array; and wherein the aperture array is accommodated in the housing.

18. The image exposing apparatus according to claim 9, wherein an aperture array is disposed on the front or rear side of the microlens array, the aperture array having apertures, each corresponding to each of the microlenses of the microlens array; and wherein the aperture array is accommodated in the housing.

19. The image exposing apparatus according to claim 10, wherein an aperture array is disposed on the front or rear side of the microlens array, the aperture array having apertures, each corresponding to each of the microlenses of the microlens array; and wherein the aperture array is accommodated in the housing.

20. A microlens array unit, comprising:
a microlens array having microlenses arranged in an array; and
a housing for accommodating the microlens array, the housing having two transparent sections for transmitting the light to be passed through the microlens array and the light passed therethrough respectively.
